(19) United States
(12) Patent Application Publication
(10) Pub. No.: US 2020/0164734 A1
(43) Pub. Date: May 28, 2020

(54) HYBRID ELECTRIC POWERTRAIN CONFIGURATIONS WITH A BALL VARIATOR USED AS A CONTINUOUSLY VARIABLE MECHANICAL TRANSMISSION

(71) Applicant: DANA LIMITED, MAUMME, OH (US)

(72) Inventors: JEFFREY M. DAVID, CEDAR PARK, TX (US); RAYMOND J. HAKA, BRIGHTON, MI (US); KRISHNA KUMAR, HOLLAND, OH (US); ROBERT A. SMITHSON, LEANDER, TX (US); WILLIAM F. WALTZ, TOLEDO, OH (US); STEVEN J. WESOLOWSKI, WATERVILLE, OH (US); JAMES F. ZIECH, KALAMAZOO, MI (US)

(73) Assignee: DANA LIMITED, MAUMEE, OH (US)

(21) Appl. No.: 15/760,653

(22) PCT Filed: Sep. 16, 2016
(86) PCT No.: PCT/US2016/052076

§ 371 Date: Mar. 16, 2018

Related U.S. Application Data
(60) Provisional application No. 62/220,019, filed on Sep. 17, 2015.

(51) Int. Cl. B60K 6/543; B60K 6/26; B60K 6/365; F16H 37/02; F16H 15/52; F16H 37/08

(52) U.S. Cl. CPC B60K 6/543; B60K 6/26; B60K 6/365; F16H 37/022; F16H 2702/02; F16H 37/0826; B60Y 2200/92; B60Y 2400/72; B60Y 2400/73; F16H 15/52

(57) ABSTRACT

Regular series-parallel hybrid electric powertrains (powersplit eCVT) are two-motor HEV propulsion systems mated with a planetary gear, and most mild or full parallel hybrid systems are single motor systems with a gearbox or continuously variable transmission (CVT) coupled with an electric machine. Coupling a ball-type continuously variable planetary (CVP), such as a VariGlide®, with one electric machine enables the creation of a parallel HEV architecture with the CVP functioning as a continuously variable transmission, and the motor providing the functionality of electric assist, starter motor capability, launch assist and regenerative braking. Two motor variants provide series-parallel hybrid electric vehicle (HEV) architectures. Embodiments disclosed herein, coupled with a hybrid supervisory controller that chooses the path of highest efficiency from engine to wheel, leads to the creation of a hybrid powertrain that are capable of operating at the best potential overall efficiency point in any mode and also provide torque variability.

### CROSS-REFERENCES TO RELATED APPLICATIONS

The present application claims the benefit of U.S. Provisional Patent Application No. 62/220,019, filed Sep. 17, 2015 which application is incorporated herein by reference.

### BACKGROUND OF THE INVENTION

Hybrid vehicles are enjoying increased popularity and acceptance due in large part to the cost of fuel and greenhouse carbon emission government regulations for internal combustion engine vehicles. Such hybrid vehicles include both an internal combustion engine as well as an electric motor to propel the vehicle.

### SUMMARY OF THE INVENTION

In current designs for both consuming as well as storing electrical energy, the rotary shaft from a combination electric motor/generator is coupled by a gear train or planetary gear set to the main shaft of an internal combustion engine. As such, the rotary shaft for the electric motor/generator unit rotates in unison with the internal combustion engine main shaft at the fixed ratio of the hybrid vehicle design.

These fixed ratio designs have many disadvantages, for example the electric motor/generator unit achieves its most efficient operation, both in the sense of generating electricity and also providing additional power to the main shaft of the internal combustion engine, only within a relatively narrow range of revolutions per minute of the motor/generator unit. However, since the previously known hybrid vehicles utilized a fixed speed ratio between the motor/generator unit and the internal combustion engine main shaft, the motor/generator unit oftentimes operates outside its optimal speed range. As such, the overall hybrid vehicle operates at less than optimal efficiency. Therefore, there is a need for powertrain configurations that improve the efficiency of hybrid vehicles.

Regular series-parallel hybrid electric powertrains (powersplit eCVT) are two-motor HEV propulsion systems mated with a planetary gear, and most mild or full parallel hybrid systems are single motor systems with a gearbox or continuously variable transmission (CVT) coupled with an electric machine. Coupling a ball-type continuously variable planetary (CVP), such as a VariGlide®, with one electric machine enables the creation of a parallel HEV architecture with the CVP functioning as a continuously variable transmission, and the motor providing the functionality of electric assist, starter motor capability, launch assist and regenerative braking. The dual motor variant opens up the possibility of a series-parallel hybrid electric vehicle (HEV) architecture. Embodiments disclosed herein, coupled with a hybrid supervisory controller that chooses the path of highest efficiency from engine to wheel, provides a means to optimize the operation of the engine and motor/generator, thereby providing a hybrid powertrain that will operate at the best potential overall efficiency point in any mode and also provide torque variability, thereby leading to the best combination of powertrain performance and fuel efficiency that will exceed current industry standards especially in the mild-hybrid and parallel hybrid light vehicle segments.

Provided herein is a powertrain comprising: at least one motor/generator; an engine; and a continuously variable planetary transmission comprising a plurality of balls, a first traction ring, a second traction ring, a sun, and a carrier, wherein each ball of the plurality of balls is provided with a tiltable axis of rotation, each ball is in contact with the first traction ring and the second traction ring, each ball is in contact with a sun wherein the sun is located radially inward of each ball, and each ball is operably coupled to the carrier which is operably coupled to a shift actuator, wherein the engine is operably coupled to the first traction ring, and wherein the carrier is grounded and non-rotating. In some embodiments, a first motor/generator is operably coupled to the sun. In some embodiments, a second motor/generator is operably coupled to the second traction ring. In some embodiments, the powertrain comprises a first clutch operably coupled to the second motor/generator, wherein the first clutch is arranged to selectively engage the second traction ring. In some embodiments, the powertrain comprises a first clutch operably coupled to the first motor/generator, wherein the first clutch is adapted to selectively engage the sun. In some embodiments, the powertrain comprises a brake operably coupled to the second traction ring. In some embodiments, the second motor/generator is operably coupled to a final drive gear. In some embodiments, the powertrain comprises a powertrain supervisory controller, wherein the controller is configured to supply control signals to the powertrain or components thereof such that the said controller dynamically affects a plurality of operating modes of the powertrain.

Provided herein is a powertrain comprising: at least one motor/generator; an engine; a first clutch coupled to the engine; and a continuously variable planetary transmission comprising a plurality of balls, a first traction ring, a second traction ring, a sun, and a carrier, wherein each ball is provided with a tiltable axis of rotation, each ball is in contact with the first traction ring and the second traction ring, each ball is in contact with the sun, wherein the sun is located radially inward of each ball, and each ball is operably coupled to the carrier, wherein the carrier is operably coupled to a shift actuator, wherein the engine is selectively coupled to the first traction ring, and wherein the carrier is grounded and non-rotating. In some embodiments, a first motor/generator is operably coupled to the sun. In some embodiments, a second motor/generator is operably coupled to the second traction ring. In some embodiments, the powertrain comprises a second clutch operably coupled to the second motor/generator, wherein the second clutch is arranged to selectively engage the second traction ring. In some embodiments, the powertrain comprises a second clutch operably coupled to the first motor/generator, wherein the first clutch is adapted to selectively engage the sun. In some embodiments, the powertrain comprises a brake operably coupled to the second traction ring. In some embodiments, the second motor/generator is operably coupled to a final drive gear. In some embodiments, the powertrain comprises a powertrain supervisory controller, wherein the controller is configured to supply control signals to the powertrain or components thereof such that the said controller dynamically affects a plurality of operating modes of the powertrain.

Provided herein is a powertrain comprising: at least one motor/generator; an engine; a first clutch coupled to the engine; and a continuously variable planetary transmission comprising a plurality of balls, a first traction ring in contact with each ball of the plurality of balls, a second traction ring in contact with each ball of the plurality of balls, a sun located radially inward of each ball of the plurality of balls and in contact with each ball of the plurality of balls, a carrier operably coupled to each ball of the plurality of balls and operably coupled to a shift actuator, wherein each ball of the plurality of balls is provided with a tiltable axis of rotation, wherein the engine is selectively coupled to the first traction ring, and wherein the carrier is grounded and non-rotating. In some embodiments, a first motor/generator is operably coupled to the sun. In some embodiments, a second motor/generator is operably coupled to the second traction ring. In some embodiments, the powertrain comprises a second clutch operably coupled to the second motor/generator, wherein the second clutch is arranged to selectively engage the second traction ring. In some embodiments, the powertrain comprises a second clutch operably coupled to the first motor/generator, wherein the first clutch is adapted to selectively engage the sun. In some embodiments, the powertrain comprises a brake operably coupled to the second traction ring. In some embodiments, the second motor/generator is operably coupled to a final drive gear. In some embodiments, the powertrain comprises a powertrain supervisory controller, wherein the controller is configured to supply control signals to the powertrain or components thereof such that the said controller dynamically affects a plurality of operating modes of the powertrain.

Provided herein is a powertrain comprising: at least one motor/generator; an engine; a continuously variable planetary transmission (CVP) comprising a plurality of balls, a first traction ring, a second traction ring, a sun, and a carrier; and a planetary gearbox operably coupled to the CVP and the first motor/generator; wherein each ball is provided with a tiltable axis of rotation, each ball is in contact with the first traction ring and the second traction ring, each ball is in contact with a sun, wherein the sun is located radially inward of each ball, and each ball is operably coupled to the carrier, wherein the carrier is operably coupled to a shift actuator, and wherein the carrier is grounded. In some embodiments, the planetary gearbox is operably coupled to a second motor/generator. In some embodiments, the planetary gearbox is operably coupled to the engine. In some embodiments, the engine is operably coupled to the first traction ring, and the planetary gearbox is operably coupled to the second traction ring. In some embodiments, the planetary gearbox is operably coupled to the engine, and a second motor/generator is operably coupled to the second traction ring. In some embodiments, the planetary gearbox is operably coupled to the first traction ring and the sun. In some embodiments, the powertrain comprises a powertrain supervisory controller, wherein the controller is configured to supply control signals to the powertrain or components thereof such that the said controller dynamically affects a plurality of operating modes of the powertrain.

Provided herein is a powertrain comprising: at least one motor/generator; an engine; a continuously variable planetary transmission (CVP) comprising a plurality of balls, a first traction ring in contact with each ball of the plurality of balls, a second traction ring in contact with each ball of the plurality of balls, a sun located radially inward of each ball of the plurality of balls and in contact with each ball of the plurality of balls, a carrier operably coupled to each ball of the plurality of balls and operably coupled to a shift actuator, wherein each ball of the plurality of balls is provided with a tiltable axis of rotation, and wherein the carrier is grounded. In some embodiments, the planetary gearbox is operably coupled to a second motor/generator. In some embodiments, the planetary gearbox is operably coupled to the engine. In some embodiments, the engine is operably coupled to the first traction ring, and the planetary gearbox is operably coupled to the second traction ring. In some embodiments, the planetary gearbox is operably coupled to the engine, and a second motor/generator is operably coupled to the second traction ring. In some embodiments, the planetary gearbox is operably coupled to the first traction ring and the sun. In some embodiments, the powertrain comprises a powertrain supervisory controller, wherein the controller is configured to supply control signals to the powertrain or components thereof such that the said controller dynamically affects a plurality of operating modes of the powertrain.

Provided herein is a powertrain comprising: at least one hydro-mechanical machine; an engine; and a continuously variable planetary transmission comprising a plurality of balls, a first traction ring, a second traction ring, a sun, and a carrier, wherein each ball is provided with a tiltable axis of rotation, each ball is in contact with the first traction ring and the second traction ring, each ball is in contact with the sun, wherein the sun is located radially inward of each ball, and each ball is operably coupled to a carrier, wherein the carrier is operably coupled to a shift actuator, wherein the engine is operably coupled to the first traction ring, and wherein the carrier is grounded and non-rotating. In some embodiments, a first hydro-mechanical machine is operably coupled to the sun. In some embodiments, a second hydro-mechanical machine is operably coupled to the second traction ring. In some embodiments, the powertrain comprises a first clutch operably coupled to the second hydro-mechanical machine, wherein the first clutch is arranged to selectively engage the second traction ring. In some embodiments, the powertrain comprises a first clutch operably coupled to the first hydro-mechanical machine, wherein the first clutch is adapted to selectively engage the sun. In some embodiments, the powertrain comprises a brake operably coupled to the second traction ring. In some embodiments, the second hydro-mechanical machine is operably coupled to a final drive gear. In some embodiments, the powertrain comprises a powertrain supervisory controller, wherein the controller is configured to supply control signals to the powertrain or components thereof such that the said controller dynamically affects a plurality of operating modes of the powertrain.

Provided herein is a powertrain comprising: at least one hydro-mechanical machine; an engine; and a continuously variable planetary transmission comprising a plurality of balls, a first traction ring in contact with each ball of the plurality of balls, a second traction ring in contact with each ball of the plurality of balls, a sun located radially inward of each ball of the plurality of balls and in contact with each ball of the plurality of balls, a carrier operably coupled to each ball of the plurality of balls and operably coupled to a shift actuator, wherein each ball of the plurality of balls is provided with a tiltable axis of rotation, wherein the engine is operably coupled to the first traction ring, and wherein the carrier is grounded and non-rotating. In some embodiments, a first hydro-mechanical machine is operably coupled to the sun. In some embodiments, a second hydro-mechanical machine is operably coupled to the second traction ring. In some embodiments, the powertrain comprises a first clutch operably coupled to the second hydro-mechanical machine, wherein the first clutch is arranged to selectively engage the second traction ring. In some embodiments, the powertrain comprises a first clutch operably coupled to the first hydro-mechanical machine, wherein the first clutch is adapted to selectively engage the sun. In some embodiments, the powertrain comprises a brake operably coupled to the second traction ring. In some embodiments, the second hydro-mechanical machine is operably coupled to a final drive gear. In some embodiments, the powertrain comprises a powertrain supervisory controller, wherein the controller is configured to supply control signals to the powertrain or components thereof such that the said controller dynamically affects a plurality of operating modes of the powertrain.

Provided herein is a vehicle comprising: a first axle; a second axle; a drivetrain comprising a ball-planetary continuously variable transmission operably coupled to the first axle; and an electric drive system operably coupled to the second axle. In some embodiments, the ball-planetary continuously variable transmission comprises a plurality of balls, a first traction ring in contact with each ball of the plurality of balls, a second traction ring in contact with each ball of the plurality of balls, a sun located radially inward of each ball of the plurality of balls and in contact with each ball of the plurality of balls, a carrier operably coupled to each ball of the plurality of balls and operably coupled to a shift actuator, wherein each ball of the plurality of balls is provided with a tiltable axis of rotation. In some embodiments, the electric drive system further comprises at least one motor-generator.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic diagram of a hybrid powerpath having a planetary gear system.

FIG. 5 is another schematic diagram of a hybrid powerpath having a planetary gear system.

FIG. 6 is another schematic diagram of a hybrid powerpath having a planetary gear system.

FIG. 7 is a schematic diagram of a pre-transmission mild hybrid single motor, 2 clutch parallel hybrid architecture having a ball planetary transmission, a motor/generator, and an engine.

FIG. 8 is another schematic diagram of a post-transmission mild hybrid single motor, 2 clutch parallel hybrid architecture having a ball planetary transmission, a motor/generator, and an engine.

FIG. 9 is a schematic diagram of a series parallel hybrid dual motor architecture having a ball planetary transmission, two motor/generators, and an engine.

FIG. 10 is a schematic diagram of a series parallel hybrid one clutch variant architecture having a ball planetary transmission, two motor/generators, an engine, and a clutch.

FIG. 11 is another schematic diagram of a series parallel hybrid two clutch variant dual motor architecture having a ball planetary transmission, two motor/generators, an engine, and a two clutches.

FIG. 12 is a schematic diagram of a series parallel hybrid, no clutches, dual motor architecture having a ball planetary transmission, two motor/generators, and an engine.

FIG. 13 is a schematic diagram of a series parallel hybrid one clutch variant, dual motor architecture having a ball planetary transmission, two motor/generators, an engine, and a clutch.

FIG. 14 is a schematic diagram of a series parallel hybrid two clutch variant, dual motor architecture having a ball planetary transmission, two motor/generators, an engine, and two clutches.

FIG. 15 is a schematic diagram of a series parallel hybrid one clutch, one brake variant, dual motor architecture having a ball planetary transmission, two motor/generators, an engine, a brake, and a clutch.

FIG. 16 is another schematic diagram of a series parallel hybrid one clutch, one brake variant, dual motor architecture having a ball planetary transmission, two motor/generators, an engine, a brake, and a clutch.

FIG. 17 is a schematic diagram of an all-wheel drive, dual motor series parallel hybrid.

FIG. 18 is a schematic diagram of another all-wheel drive, dual motor series parallel hybrid architecture having a ball planetary transmission, two motor/generators, and an engine.

FIG. 19 is another schematic diagram of an all-wheel drive series parallel hybrid, dual motor architecture having a ball planetary transmission, two motor/generators, an engine, a brake, and two clutches.

FIG. 20 is another schematic diagram of a series parallel hybrid, dual motor, two clutch architecture having a ball planetary transmission, two motor/generators, an engine, a brake, and two clutches.

FIG. 21 is a schematic diagram of a series parallel hybrid, dual motor, two clutch architecture having a ball planetary transmission, two motor/generators, an engine, a brake, and two clutches.

FIG. 22 is another schematic diagram of a series parallel hybrid, switchable dual motor architecture having a ball planetary transmission, two motor/generators, an engine, a brake, and two clutches.

FIG. 23 is a schematic diagram of a series parallel hybrid with a bypassable variator and switchable variator architecture having a ball planetary transmission, two motor/generators, an engine, a brake, and three clutches.

FIG. 24 is a schematic diagram of a series parallel hybrid eCVT and mechanical CVT dual motor architecture having a ball planetary transmission, two motor/generators, an engine, and a planetary gearbox.

FIG. 25 is another schematic diagram of a series parallel hybrid eCVT and mechanical CVT dual motor architecture having a ball planetary transmission, two motor/generators, an engine, and a planetary gearbox.

FIG. 26 is another schematic diagram of a series parallel hybrid eCVT and mechanical CVT dual motor (split) architecture having a ball planetary transmission, two motor/generators, an engine, and a planetary gearbox.

FIG. 27 a-d are schematic diagrams of series-parallel hybrid architecture during different operating conditions.

FIG. 28 is a schematic diagram of a hybrid architecture having a ball planetary transmission.

FIG. 29 is a schematic diagram of another hybrid architecture having a ball planetary transmission.

FIG. 30 is a schematic diagram of yet another hybrid architecture having a ball planetary transmission.

FIG. 31 is a schematic diagram of a vehicle having a hybrid architecture having a ball planetary transmission.

### DETAILED DESCRIPTION OF THE INVENTION

In current designs for both consuming as well as storing electrical energy, the rotary shaft from a combination electric motor/generator is coupled by a gear train or planetary gear set to the main shaft of an internal combustion engine. As such, the rotary shaft for the electric motor/generator unit rotates in unison with the internal combustion engine main shaft at the fixed ratio of the hybrid vehicle design.

These fixed ratio designs have many disadvantages, for example the electric motor/generator unit achieves its most efficient operation, both in the sense of generating electricity and also providing additional power to the main shaft of the internal combustion engine, only within a relatively narrow range of revolutions per minute of the motor/generator unit. However, since the previously known hybrid vehicles utilized a fixed speed ratio between the motor/generator unit and the internal combustion engine main shaft, the motor/generator unit oftentimes operates outside its optimal speed range. As such, the overall hybrid vehicle operates at less than optimal efficiency. Therefore, there is a need for powertrain configurations that improve the efficiency of hybrid vehicles.

This powertrain relates to electric powertrain configurations and architectures that will be used in hybrid vehicles. The powertrain and/or drivetrain configurations use a ball planetary style continuously variable transmission, such as the VariGlide®, in order to couple power sources used in a hybrid vehicle, for example, combustion engines (internal or external), motors, generators, batteries, and gearing.

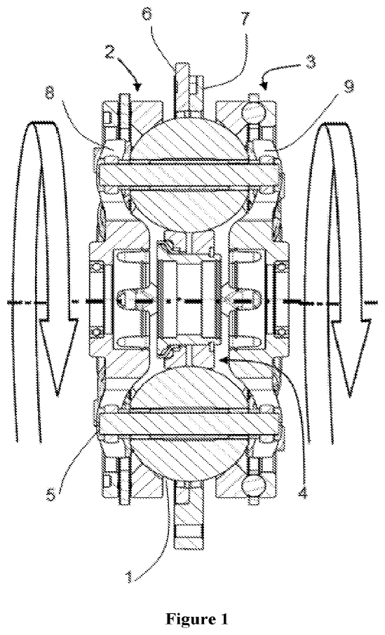

A typical ball planetary variator CVT design, such as that described in United States Patent Publication No. 2008/0121487 and in U.S. Pat. No. 8,469,856, both incorporated herein by reference in their entirety, represents a rolling traction drive system, transmitting forces between the input and output rolling surfaces through shearing of a thin fluid film. The technology is called Continuously Variable Planetary (CVP) due to its analogous operation to a planetary gear system. The system consists of an input disc (ring or traction ring) driven by the power source, an output disc (ring or traction ring) driving the CVP output, a set of balls fitted between these two discs and a central sun, as illustrated in FIG. 1. The balls are able to rotate around their own respective axle by the rotation of two carrier disks at each end of the set of balls axles. The system is also referred to as the Ball-Type Variator.

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments of the invention. Furthermore, embodiments of the invention include several novel features, no single one of which is solely responsible for its desirable attributes or which is essential to practicing the inventions described.

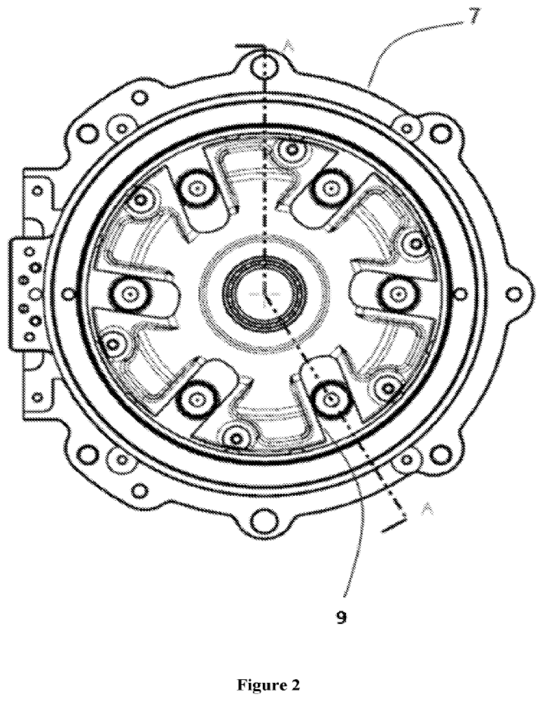

Provided herein are configurations of CVTs based on a ball type variators, also known as CVP, for continuously variable planetary. Basic concepts of a ball type Continuously Variable Transmissions are described, as previously noted in U.S. Pat. No. 8,469,856 and also in U.S. Pat. No. 8,870,711 incorporated herein by reference in their entirety. Such a CVT, adapted herein as described throughout this specification, comprises a number of balls (planets, spheres) 1, depending on the application, two ring (disc or traction ring) assemblies with a conical surface contact with the balls, as input or traction ring 2, and output or traction ring 3, and an idler (sun) assembly 4 as shown on FIG. 1. In some embodiments, the input ring 2 is referred to in illustrations and referred to in text by the label “R1” and/or as a first traction ring. The output ring is referred to in illustrations and referred to in text by the label “R2” and/or as a second traction ring. The idler (sun) assembly is referred to in illustrations and referred to in text by the label “S”. The balls are mounted on tiltable axles 5, themselves held in a carrier (stator, cage) assembly having a first carrier member 6 operably coupled to a second carrier member 7. In some embodiments, the carrier assembly is denoted in illustrations and referred to in text by the label “C”. These labels are collectively referred to as nodes (“R1”, “R2”, “S”, “C”). The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 9 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, such as described in U.S. Pat. No. 6,461,268, but are slightly different.

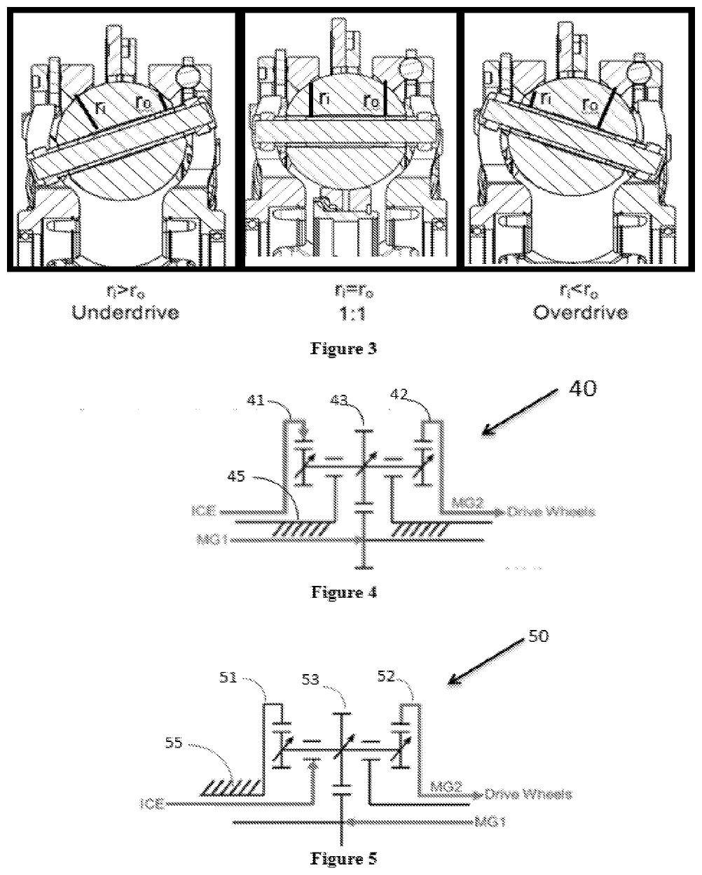

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments of the invention disclosed here are related to the control of a variator and/or a CVT using generally spherical planets each having a tiltable axis of rotation that is adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling is capable of taking a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these will be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (p) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here are capable of operating in both tractive and frictional applications. For example, in the embodiment where a CVT is used for a bicycle application, the CVT operates at times as a friction drive and at other times as a traction drive, depending on the torque and speed conditions present during operation.

As used herein, and unless otherwise specified, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 30%, 25%, 20%, 15%, 10%, 9%, 8%, 7%, 6%, 5%, 4%, 3%, 2%, 1%, 0.5%, 0.1%, or 0.05% of a given value or range. In certain embodiments, the term “about” or “approximately” means within 40.0 mm, 30.0 mm, 20.0 mm, 10.0 mm 5.0 mm 1.0 mm, 0.9 mm, 0.8 mm, 0.7 mm, 0.6 mm, 0.5 mm, 0.4 mm, 0.3 mm, 0.2 mm or 0.1 mm of a given value or range. In certain embodiments, the term “about” or “approximately” means within 20.0 degrees, 15.0 degrees, 10.0 degrees, 9.0 degrees, 8.0 degrees, 7.0 degrees, 6.0 degrees, 5.0 degrees, 4.0 degrees, 3.0 degrees, 2.0 degrees, 1.0 degrees, 0.9 degrees, 0.8 degrees, 0.7 degrees, 0.6 degrees, 0.5 degrees, 0.4 degrees, 0.3 degrees, 0.2 degrees, 0.1 degrees, 0.09 degrees. 0.08 degrees, 0.07 degrees, 0.06 degrees, 0.05 degrees, 0.04 degrees, 0.03 degrees, 0.02 degrees or 0.01 degrees of a given value or range.

As used herein, the terms “comprises”, “comprising”, or any other variation thereof, are intended to cover a nonexclusive inclusion, such that a process, method, article, or apparatus that comprises a list of elements does not include only those elements but may include other elements not expressly listed or inherent to such process, method, article, or apparatus.

Referring now to FIG. 4, in some embodiments using a continuously variable CVP 100 as described previously in FIGS. 1-3, a hybrid powertrain architecture is shown with a fixed ratio planetary powertrain 40, comprising a first ring (R1) 41, a second ring (R2) 42, a sun (S) 43, and a carrier (C) 45, wherein an internal combustion engine (ICE) is coupled to a fixed carrier 45 planetary. A first motor/generator MG1 is configured to control speed/power. The first motor/generator MG1 in the embodiment of FIG. 4 is inside the CVP 100 cam drivers, sometimes referred to as axial force generators operably coupled to the first traction ring 41 and the second traction ring 43. In some embodiments, the first motor/generator MG1 operates at speeds as high as 30,000 rpm to 40,000 rpm. One of skill in the art will recognize that the first motor/generator, MG1, is optionally configured to be small in size for its relative power. A second motor/generator, MG2, is configured to control torque. The second motor/generator MG2 drive layout of FIG. 4 may not take advantage of the CVP 100 multiplication in some embodiments, although in some embodiments it may optionally do so.

Passing to FIG. 5, in some embodiments using a CVP 100 as described previously, a hybrid vehicle is shown with a fixed ratio planetary powertrain 50, comprising a first ring (R1) 51, a second ring (R2) 52, a sun (S) 53, and a carrier (C) 55, having an ICE arranged on a high inertia powerpath. The embodiment of FIG. 5 comprises a fixed carrier. In some embodiments, an infinitely variable transmission having a rotatable carrier is coupled to the ICE to enable reverse operation and vehicle launch. The first motor/generator, MG1, is configured to control speed/power. The second motor/generator, MG2, is configured to control torque. The ICE is configured to operate in a high inertia powerpath. The ICE is arranged to react inertias of the first motor/generator MG1 and the second motor/generator MG2 under driving conditions of the vehicle. In some embodiments, the ICE operates at high speeds similar to those speeds typical of a gas turbine. In some embodiments, a step up gear is coupled to the ICE to provide a high speed input to the system.

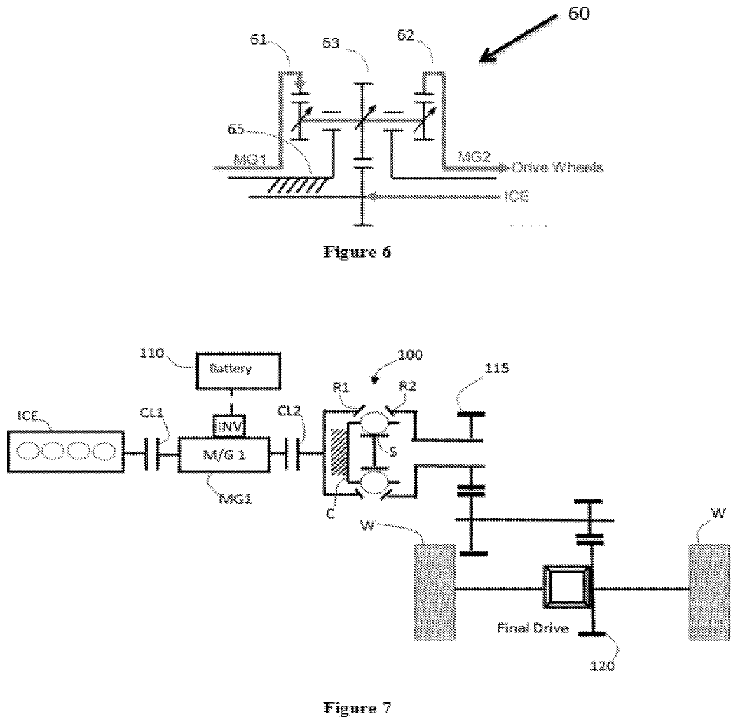

Turning now to FIG. 6, in some embodiments using a CVP, a hybrid vehicle is shown with a fixed ratio planetary powertrain 60, comprising a first ring (R1) 61, a second ring (R2) 62, a sun (S) 63, and a carrier (C) 65, having an ICE arranged on a high speed powerpath and configured to react with the first motor/generator, MG1, and the second motor/generator, MG2, during operation. The embodiment of FIG. 6 comprises a fixed carrier. The ICE is configured to operate in a high speed powerpath. The ICE is arranged to react the first motor/generator MG1 and the second motor/generator MG2 during driving conditions. The ICE can optionally be a very high speed input, such as a gas turbine, or the ICE is optionally coupled to a step up gear.

Embodiments disclosed herein are directed to hybrid vehicle architectures and/or configurations that incorporate a CVP in place of a regular fixed ratio planetary leading to a continuously variable parallel hybrid. It should be appreciated that the embodiments disclosed herein are adapted to provide hybrid modes of operation that include, but are not limited to series, parallel, series-parallel, or EV (electric vehicle) modes. The core element of the power flow is a CVP, such as the continuously variable transmission described in FIGS. 1-3, which functions as a continuously variable transmission having four of nodes (R1, R2, C, and S), wherein the carrier (C) is grounded, the rings (R1 and R2) are available for output power, and the sun or sun gear (S) providing a variable ratio, and, in some embodiments, an auxiliary drive system. The CVP enables the engine (ICE) and electric machines (motor/generators, among others) to run at an optimized overall efficiency. It should be noted that hydro-mechanical components such as hydromotors, pumps, accumulators, among others, are capable of being used in place of the electric machines indicated in the figures and accompanying textual description. Furthermore, it should be noted that embodiments of hybrid architectures disclosed herein incorporate a hybrid supervisory controller that chooses the path of highest efficiency from engine to wheel. Embodiments disclosed herein enable hybrid powertrains that are capable of operating at the best potential overall efficiency point in any mode and also provide torque variability, thereby leading to the optimal combination of powertrain performance and fuel efficiency. It should be understood that hybrid vehicles incorporating embodiments of the hybrid architectures disclosed herein are capable of including a number of other powertrain components, such as, but not limited to, high-voltage battery pack with a battery management system or ultracapacitor, on-board charger, DC-DC converters, or DC-AC inverters, a variety of sensors, actuators, and controllers, among others. For description purposes, a battery 110 referred to herein and depicted or implied in FIGS. 4-31, is an illustrative example of a battery storage device.

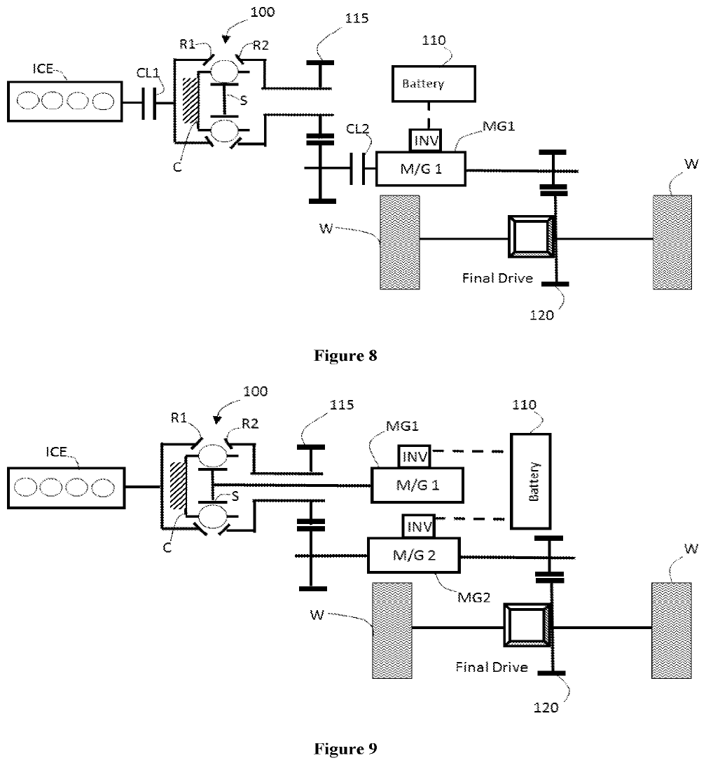

FIGS. 7 and 8 depict embodiments of hybrid vehicle architectures that include an internal combustion engine (referred to in text and labeled in figures as “ICE”) coupled by a first clutch (referred to in text and labeled in figures as “CL1”) to a first motor/generator (referred to in text and labeled in figures as “MG1” or “M/G 1”). The first motor/generator MG1 is coupled by a second clutch (referred to in text and labeled in figures as “CL2”) to a variator 100 (sometimes referred to in text and labeled in figures as “CVP 100”). The CVP 100 is optionally configured as depicted and described in reference to FIGS. 1-3. The architectures depicted in FIGS. 7 and 8 are sometimes referred to as parallel hybrid systems. An Inverter (INV), an apparatus that converts direct current into alternating current, is operationally coupled to and a component of each motor/generator. Referring specifically to FIG. 7, the second clutch, CL2, is configured to selectively couple to the first traction ring, R1, of the CVP 100. The carrier node, C, of the CVP 100 is a grounded member. Power is transmitted out of the CVP 100 on the second traction ring, R2. In some embodiments, a first transfer gear set 115 is provided to operably couple the second traction ring R2 to a final drive gear set 120. It should be appreciated that the final drive gear set 120 is configured to couple to wheels W of a vehicle equipped with the hybrid powertrains disclosed herein. It should be noted that the first transfer gear set 115 is optionally configured as meshing gears, sprocket and chain couplings, belt and pulley couplings, or any typical mechanical coupling configured to transmit rotational power.

Referring specifically to FIG. 8, the first clutch, CL1, is arranged to selectively couple the ICE to the first traction ring R1 of the CVP 100. The carrier node C of the CVP 100 is a grounded member. Power is transmitted out the CVP 100 on the second traction ring R2. The second clutch CL2 is arranged to selectively couple the first motor/generator MG1 to receive a power input. In some embodiments, the first transfer gear set 115 is configured to couple the second traction ring R2 to a second clutch CL2. The first motor generator MG1 is coupled to the final drive gear set 120.

Turning to FIGS. 9-23, some hybrid vehicle architectures embodiments are configured with the first motor generator MG1 and a second motor/generator MG2, (referred to in text and labeled in figures as “MG2” or “M/G 2”) arranged in systems sometimes referred to as series parallel hybrid systems. These systems are capable of running charge-sustain modes and generally offer more capabilities than the parallel hybrid systems.

Referring again to FIG. 9, the ICE is operably coupled to first traction ring R1. The carrier node C is a grounding member. The first motor/generator MG1 is operably coupled to sun S. The second motor/generator MG2 is operably coupled to the second traction ring R2 with the first transfer gear set 115. The second motor/generator MG2 is operably coupled to the final drive gear set 120.

Referring now to FIG. 10, in some embodiments, the ICE is operably coupled to the first traction ring R1. The carrier node C is a grounded member. The first motor/generator MG1 is operably coupled to the sun S. The first clutch CL1 is arranged to selectively couple the second motor/generator MG2 to the second traction ring R2 with the first transfer gear set 115. In some embodiments, the second motor/generator MG2 is operably coupled to the final drive gear set 120.

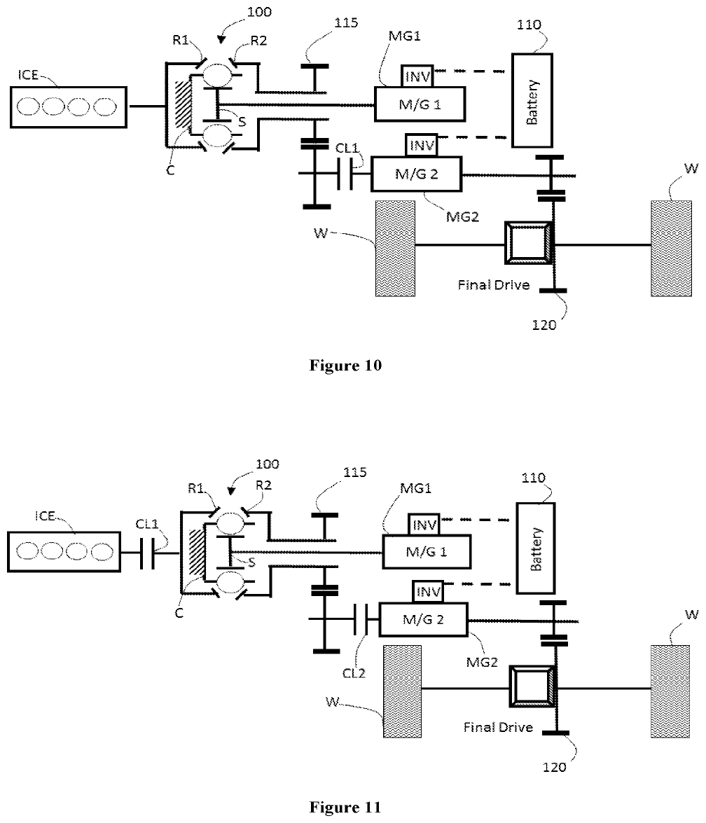

Referring now to FIG. 11, in some embodiments the first clutch CL1 is arranged to selectively couple the ICE to the first traction ring R1. The carrier node C is a grounded member. The first motor/generator MG1 is operably coupled to the sun S. The second clutch CL2 is arranged to selectively couple the second motor/generator MG2 to the second traction ring R2. In some embodiments, the first transfer gear set 115 operably coupled the second traction ring R2 to the second clutch CL2. In some embodiments, the second motor/generator MG2 is operably coupled to the final drive gear set 120.

Referring now to FIG. 12, in some embodiments the ICE is operably coupled to the first traction ring R1. The carrier node C is a grounded member. The first motor/generator MG1 is operably coupled to the second traction ring R2. The second motor/generator MG2 is operably coupled to the sun S. In some embodiments, the first transfer gear set 115 operably couples the second traction ring R2 to the first motor/generator MG1. In some embodiments, the second motor/generator MG2 is operably coupled to the final drive gear set 120.

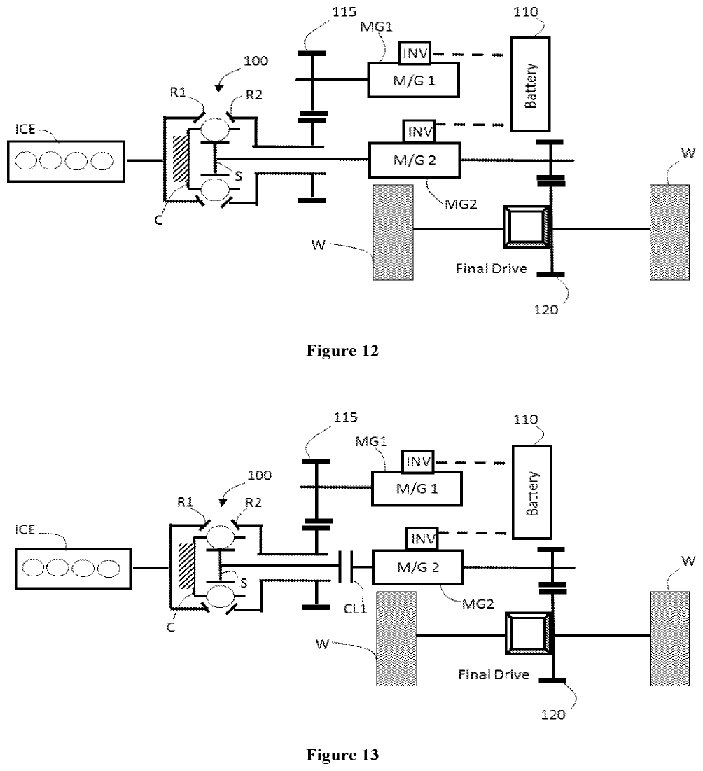

Referring now to FIG. 13, in some embodiments the ICE is operably coupled to first traction ring R1. The carrier node C is a grounded member. The first clutch CL1 is arranged to selectively couple the second motor/generator MG2 to the sun S. The first motor/generator MG1 is operably coupled to the second traction ring R2. In some embodiments, the first transfer gear set 115 is operably coupled to the second traction ring R2 and the first motor/generator MG1. In some embodiments, the second motor/generator MG2 is operably coupled to the final drive gear set 120.

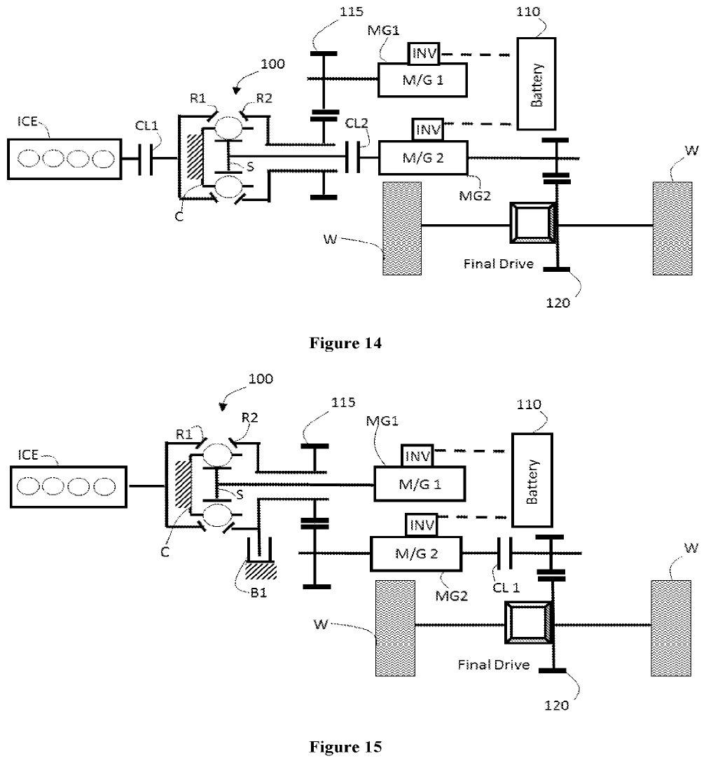

Referring now to FIG. 14, in some embodiments the first clutch CL1 is arranged to selectively couple the ICE to the first traction ring R1. The carrier node C is a grounded member. The second clutch CL2 is arranged to selectively couple the second motor/generator MG2 to the sun S. The first motor/generator MG1 is operably coupled to the second traction ring R2. In some embodiments, the first transfer gear set 115 is operably coupled to the second traction ring R2 and the first motor/generator MG1. In some embodiments, the second motor/generator MG2 is operably coupled to the final drive gear set 120.

Referring now to FIG. 15, in some embodiments, the ICE is operably coupled to the first traction ring R1. The carrier node C is a grounded member. A brake (referred to in text and labeled in figures as “B1”) is operably coupled to the second traction ring R2. The second motor/generator MG2 is operably coupled to the second traction ring R2. In some embodiments, the first transfer gear set 115 is operably coupled to the second traction ring R2 and the first motor/generator MG1. The first motor/generator MG1 is operably coupled to the sun S. The first clutch CL1 are capable of being arranged to selectively couple the second motor/generator MG2 to the final drive gear set 120.

Referring now to FIG. 16, in some embodiments, the ICE is operably coupled to the first traction ring R1. The brake B1 is operably coupled to the second traction ring R2. The first motor/generator MG1 is operably coupled to the second traction ring R2. The second motor/generator MG2 is operably coupled to the sun S. The first clutch CL1 is arranged to selectively couple to the second motor/generator MG2 to the final drive. In some embodiments, the first transfer gear set 115 is operably coupled to the second traction ring R2 and the first motor/generator MG1. In some embodiments, the second motor/generator MG2 is operably coupled by the first clutch CL1 to the final drive gear set 120.

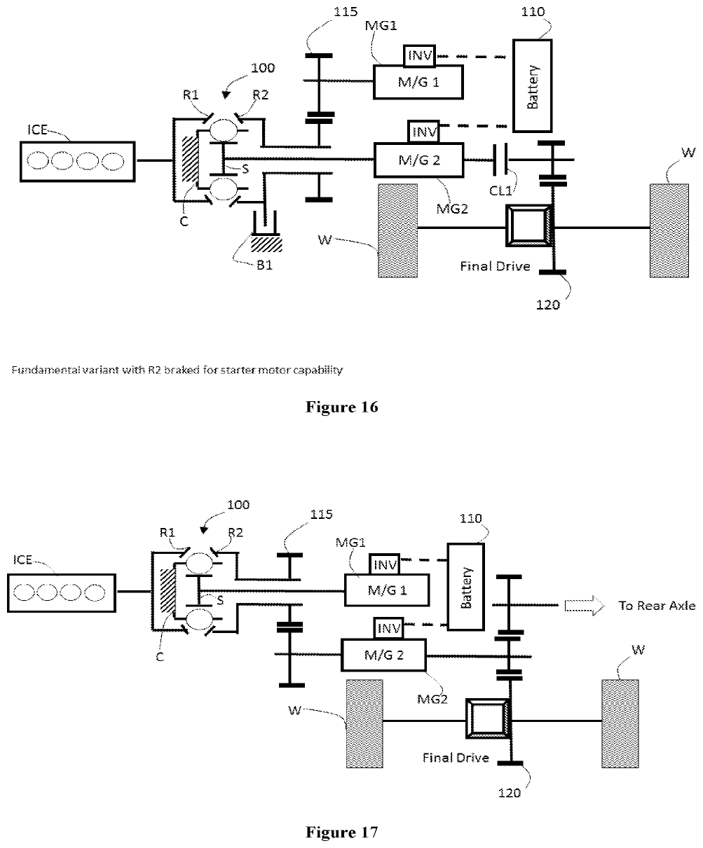

Referring now to FIG. 17, in some embodiments ICE is operably coupled to the first traction R1. The carrier node C is grounded. The first motor/generator MG1 is operably coupled to the sun S. The second motor/generator MG2 is coupled to the second traction ring R2. In some embodiments, the first transfer gear set 115 is operably coupled to the second traction ring R2 and the second motor/generator MG2. In some embodiments, the second motor/generator MG2 is operably coupled to the final drive gear set 120.

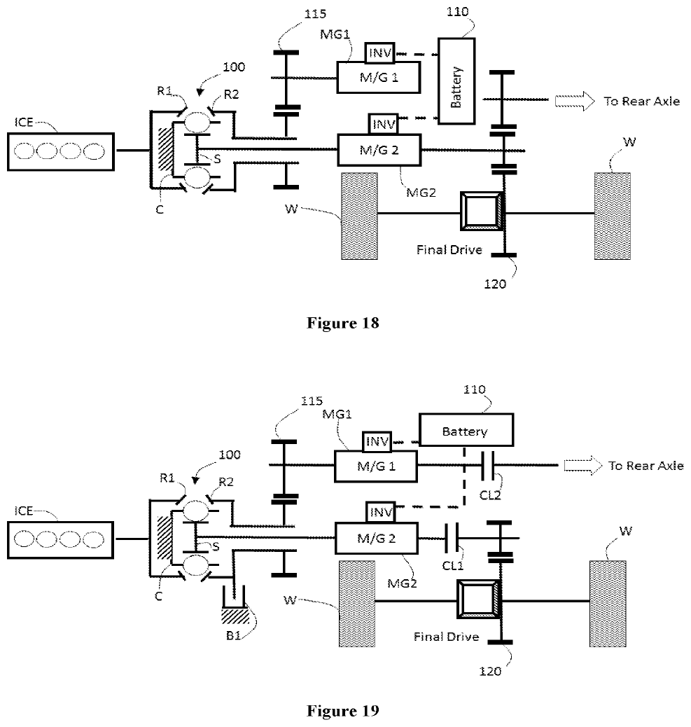

Referring now to FIG. 18, in some embodiments, the ICE is operably coupled to first traction R1. The carrier node C is a grounded member. The second motor/generator MG2 is operably coupled to the sun S. The first motor/generator MG1 is operably coupled to the second traction ring R2. The second motor/generator MG2 is operably coupled to a rear axle drive and a front axle drive. For example, the final drive gear 120 includes meshing gears adapted to transmit rotational power to a front wheel axle and a rear wheel axle. In some embodiments, the first transfer gear set 115 is operably coupled to the second traction ring R2 and the first motor/generator MG1. In some embodiments, the second motor/generator MG2 is operably coupled by the first clutch CL1 to the final drive gear set 120.

Referring now to FIG. 19, in some embodiments, the ICE is operably coupled to the first traction ring R1. The carrier node C is a grounded member. The brake B1 is operably coupled to the second traction ring R2. The first motor/generator MG1 is operably coupled to the first traction ring R1. The second motor/generator MG2 is operably coupled to the sun S. The first clutch CL1 is arranged to selectively couple the second motor/generator MG2 to the final drive gear set 120, for example, the front wheel drive. The second clutch CL2 is arranged to selectively couple the first motor/generator MG1 to the rear drive. In some embodiments, the first transfer gear set 115 operably coupled the second traction ring R2 to the first motor/generator MG1.

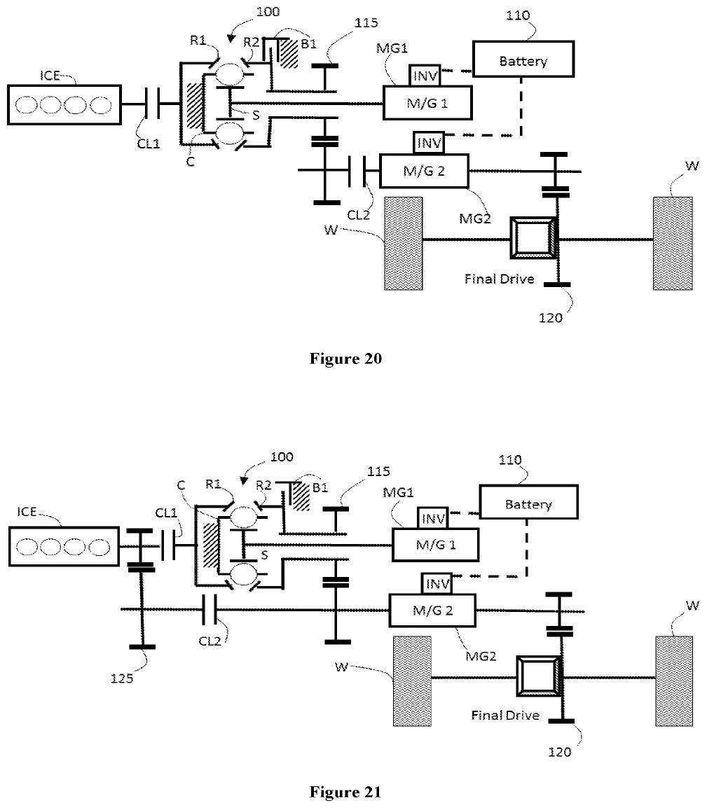

Referring now FIG. 20, in some embodiments, the ICE is selectively coupled using the first clutch CL1 to the first traction ring R1. The carrier node C is a grounded member. The brake B1 is operably coupled to the second traction ring R2. The first motor/generator MG1 is operably coupled to the sun S. The second clutch CL2 is arranged to selectively couple the second motor/generator MG2 to the second traction ring R2. In some embodiments, the first transfer gear set 115 is operably coupled to the second traction ring R2 and the second clutch CL2. The second motor/generator MG2 is operably coupled to the final drive gear set 120

Referring now to FIG. 21, in some embodiments, the ICE is selectively coupled using the first clutch CL1 to the first traction ring R1. The ICE is selectively coupled using the second clutch CL2 to the second motor/generator MG2. The first motor/generator MG1 is operably coupled to the sun S. The brake B1 is operably coupled to the second traction ring R2. The second motor/generator MG2 is operably coupled to the second traction ring R2. The carrier node C is a grounded member. In some embodiments, the first transfer gear set 115 is operably coupled to the second traction ring R2 and the second motor/generator MG2. In some embodiments, the second motor/generator MG2 is operably coupled to the final drive gear set 120. In some embodiments, a second transfer gear set 125 is operably coupled to the engine ICE and the second clutch CL2.

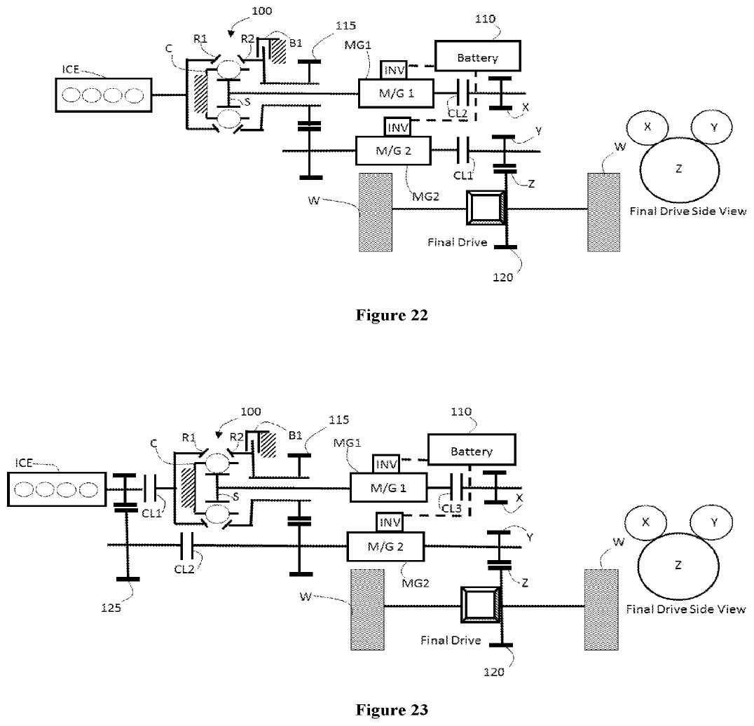

Referring now to FIG. 22, in some embodiments, the ICE is operably coupled to the first traction ring R1. The carrier node C is a grounded member. The brake B1 is operably coupled to the second traction ring R2. The second motor/generator MG2 is operably coupled to the second traction ring R2. The first motor/generator MG1 is operably coupled to the sun S. The first clutch CL1 is capable of being arranged to selectively couple the second motor/generator MG2 to the final drive gear set. In some embodiments, the final drive gear set 120 includes a first gear (referred to in text and labeled in figures as “Y”), a second gear (referred to in text and labeled in figures as “X”), and a third gear (referred to in text and labeled in figures as “Z”). The third gear Z is capable of being operably coupled to the wheels W. The second clutch CL2 is capable of being arranged to selectively couple the first motor/generator MG1 to a second gear The second gear X is capable of being operably coupled to the final drive.

Referring now to FIG. 23, in some embodiments, the ICE is capable of being selectively coupled using the first clutch CL1 to the first traction ring R1. The ICE is capable of being selectively coupled using the second clutch CL2 to the second motor/generator MG2. The carrier node C is a grounded member. The brake B1 is operably coupled to the second traction ring R2. The second motor/generator MG2 is operably coupled to the second traction ring R2. In some embodiments, the first transfer gear set 115 is operably coupled to the second traction ring R2 and the second motor/generator MG2. The first motor/generator MG1 is operably coupled to the sun S. A third clutch (referred to in text and labeled in figures as “CL3”) is arranged to selectively couple the first motor/generator MG1 to the second gear X. The second motor/generator MG2 is operably coupled to the first gear Y. In some embodiments, the second transfer gear set 125 is operably coupled to the engine ICE and the second clutch CL2. It should be appreciated that the first transfer gear 115 and the second transfer gear 125 are shown schematically as meshing gears having a fixed ratio, though one skilled in the art is capable of configuring any number of devices to operably couple the components of the hybrid powertrains disclosed herein.

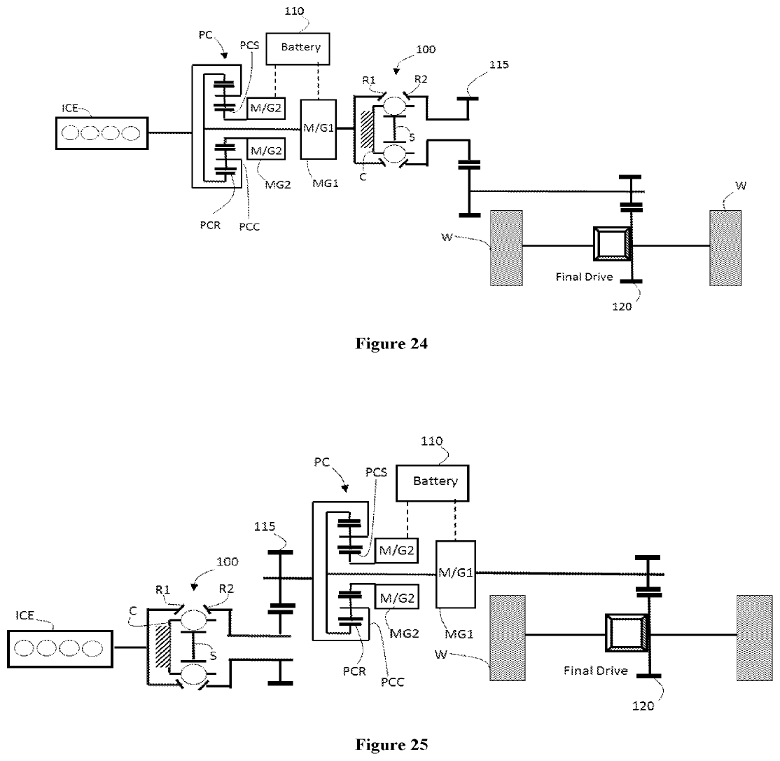

Referring now to FIGS. 24-26, in some embodiments, hybrid architectures include a simple planetary gear as a differential in combination with the CVP 100, wherein the CVP 100 has a ground carrier node C. The architecture enables a variable ratio compound split system, as opposed to a fixed ratio commonly available in compound split eCVT systems.

Referring now to FIG. 24, in some embodiments, the ICE is operably coupled to a simple planetary gearbox (referred to in text and labeled in figures as “PC”). In some embodiments, the planetary gearbox PC includes a ring gear PCR, a planet carrier PCC, and a sun gear PCS. The second motor/generator MG2 and the first motor/generator MG1 are operably coupled to PC. In some embodiments, the first motor/generator MG1 is coupled to the ring gear PCR, and the second motor/generator MG2 is coupled to the sun gear PCS. The first motor/generator MG1 is operably coupled to the first ring R1. The carrier node C is a grounded member. The second traction ring R2 is operably coupled to a final drive. In some embodiments, the first transfer gear 115 is coupled to the second traction ring R2 and the final drive gear set 120.

Referring now to FIG. 25, in some embodiments, the ICE is operably coupled to the first traction ring R1. The carrier node C is a grounded member. The second traction ring R2 is operably coupled to the planetary gearbox PC. The second motor/generator MG2 and the first motor/generator MG1 are operably coupled to the planetary gearbox PC. In some embodiments, the first motor/generator MG1 is coupled to the ring gear PCR, and the second motor/generator MG2 is coupled to the sun gear PCS. The first motor/generator MG1 is operably coupled to the final drive gear set 120 In some embodiments, the first transfer gear set 115 operably coupled the second traction ring R2 to the planet carrier PCC of the planetary gearbox PC.

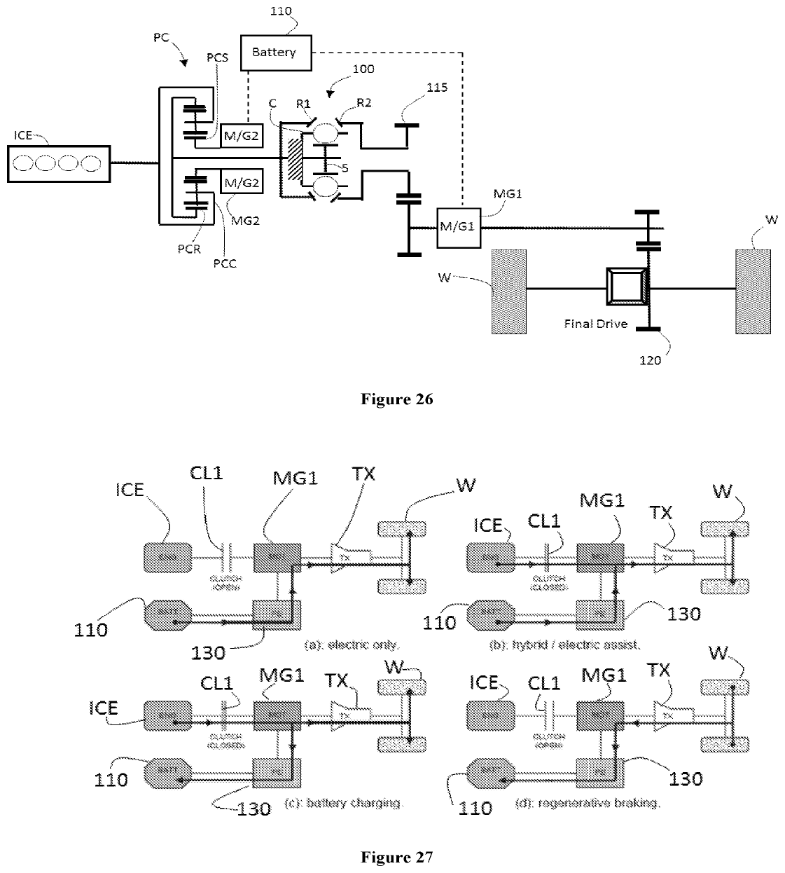

Referring now to FIG. 26, in some embodiments, the ICE is operably coupled to the planetary gearbox PC. The second motor/generator MG2 is operably coupled to the planetary gearbox PC. The planetary gearbox PC is operably coupled to the first traction ring R1. In some embodiments, the first traction ring R1 is operably coupled to the ring gear PCR. The carrier node C is a grounded member. The first motor/generator MG1 is operably coupled to the second traction ring R2. The planetary gearbox PC is operably coupled to the sun S. In some embodiments, the second motor/generator MG2 is operably coupled to the sun gear PCS. The first motor/generator MG1 is operably coupled to the final drive gear set 120. In some embodiments, the firs transfer gear 115 is operably coupled to the second traction ring R2 and the first motor/generator MG1.

Referring now to FIGS. 27a-27d, in some embodiments, a hybrid architecture includes a CVP having a grounded carrier node C. The CVP is used in a multi speed gearbox, for example, a six (6) or seven (7) speed gearbox. It should be appreciated that the hybrid architectures disclosed herein are capable of also including additional clutches, brakes, and couplings to three nodes of the CVP. For example, the multi speed gearbox (labeled in FIGS. 27a-27d as “TX”) is optionally provided with a continuously variable transmission such as those disclosed in U.S. Provisional Patent Application No. 62/343,297, which is hereby incorporated by reference. It should be appreciated that the first motor/generator MG1 is optionally arranged between the multi speed gearbox TX and the driven wheels W. In some embodiments, the engine (ICE) is coupled to the first clutch CL1. The first clutch CL1 is operably coupled to the first motor/generator MG1. The first motor/generator MG1 is in electrical communication with the battery 110 through a power inverter system 130. In some embodiments, the multi speed gearbox TX is operably coupled to the first motor/generator and provides power to the vehicle wheels W.

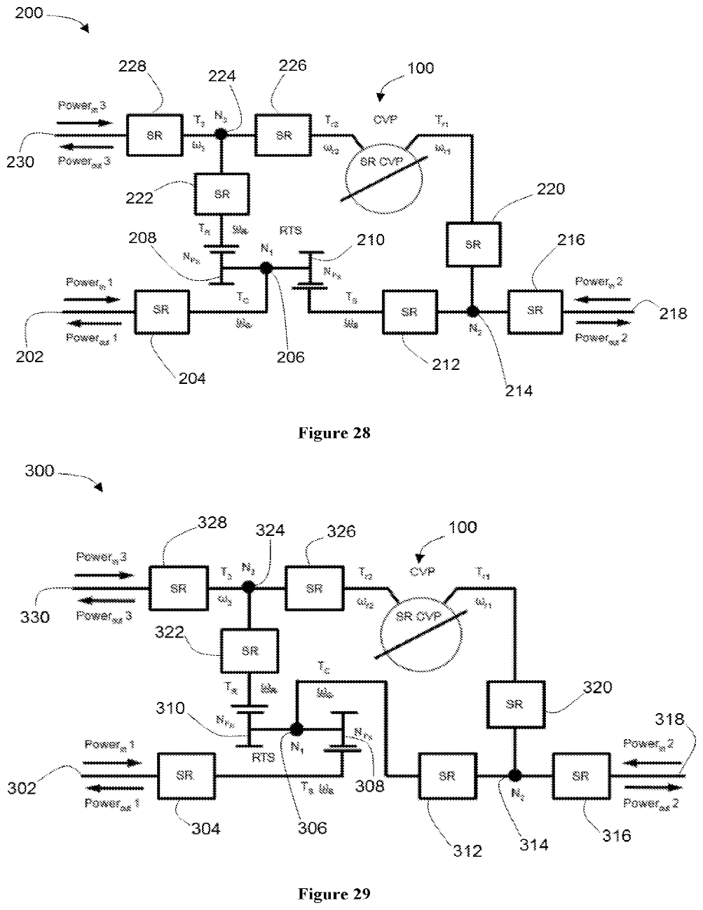

Referring now to FIGS. 28-30, in some embodiments, a hybrid drivetrain is capable of being configured with the CVP 100 (denoted as “SR CVP” in FIGS. 28-30) and a number of fixed gear sets (denoted as “SR” in FIGS. 28-30). For description purposes, in reference to FIGS. 28-30, “SR CVP” refers to the CVP speed ratio, “SR” refers to optional speed ratio increase or decrease (for example, typical meshing gear, sprocket and chain, or a belt and pulley, among other common couplings), “RTS” refers to a planetary ring to sun gear ratio, “N1, N2, N3” refers to nodes 1, 2 & 3 respectively, “T( )” refers to Torque, “ω_{( )}” refers to speed in rpm, “NP_{R}” refers to the planet pinion gear in contact with the ring number or teeth, pitch radius, pitch diameter, and “N_{P}_{_{S}}” refers to the planet pinion gear in contact with the sun gear number or teeth, pitch radius, pitch diameter. In some embodiments, input power (denoted as “Power-In 1”, “Power-In 2” or “Power-In 3”) is from an engine, a motor, or a stored energy reclamation device (electric, hydraulic, kinetic), among others. In some embodiments, output power (denoted as “Power-Out 1”, “Power-Out 2”, or “Power-Out 3”) is delivered for primary work of the device, propulsion for a vehicle (car, boat, ATV, bicycle), operation of equipment (windmill, water turbine, mill, lathe, paper mill), or energy transfer to another branch (example Power-Out 1 runs an electric generator to create electricity needed to supplement a motor at Power-In 2), among others. In some embodiments, output power is used for energy storage (electric, hydraulic, kinetic), auxiliary power take-off (PTO) such as a generator/alternator (electric, hydraulic, pneumatic), fan, air conditioning equipment, among others.

Referring now to FIGS. 28, 29, and 30, in some embodiments, hybrid powertrains include stepped planet planetaries. If the planets (N_{P}_{_{R}} & N_{P}_{_{S}}) have the same pitch diameter, then the planetary is capable of being reduced to a simple planetary. The planetary in either FIG. 28, 29, or 30 could also be a compound planetary, a dual sun gear planetary, a dual ring planetary, or two interconnected simple planetaries.

The hybrid powertrain embodiments depicted in FIGS. 28, 29, and 30 show various hybrid CVP power paths with multiple inputs and outputs (Power-In 1, Power-In 2, Power-In 3, Power-Out 1, Power-Out 2, and Power-Out 3). As an example, if one input/output is designated as the primary power-in (Power-In 1), and one input/output is designated as the primary power-out (Power-Out 2), the third Power-In/Out 3 is capable of: 1) being a second power input (to reduce the power needed at Power-In 1 and/or increase the Power-Out 2 power); 2) generating power for storage; 3) generating power for an auxiliary application; 4) generating power that is supplemented back to the primary power-in; 5) generating power that is supplemented back to the primary power-out, or; 6) generating power that is supplemented back directly to the output.

The basic configurations, of any one of FIG. 28, 29, or 30, could also be coupled to other gearing and clutches to make multi-mode hybrid transmissions. Using the previous example, the previous primary power-in (Power-In 1) is capable of remaining the primary power-in, but the previous primary power-out (Power-Out 2) is capable of becoming the new input/output (Power-In/Out 2) and the previous third input/output (Power-In/Out 3) is capable of becoming the new power-out (Power-Out 3). Thus it is easily seen that there are a multitude of combinations that can be realized.

Referring now to FIG. 28, in some embodiments, a hybrid powertrain 200 is provided with a first rotatable shaft 202 configured to transfer power in or out of the hybrid powertrain 200. The first rotatable shaft 202 is operably coupled to a first fixed ratio coupling 204. The first fixed ratio coupling 204 is coupled to a first node 206 that is adapted to couple a first planetary 208 and a second planetary 210. In some embodiments, the second planetary 210 is coupled to a second fixed ratio coupling 212. The second fixed ratio coupling 212 is coupled to a second node 214. The second node 214 is configured to couple to a third fixed ratio coupling 216. A second rotatable shaft 218 is coupled to the third fixed ratio coupling 216 and configured to transfer power in or out of the hybrid powertrain 200. In some embodiments, the second node 214 is coupled to a fourth fixed ratio coupling 220. The fourth fixed ratio coupling 220 is coupled to the first traction ring of the CVP 100. In some embodiments, the first planetary 208 is operably coupled to a fifth fixed ratio coupling 222. The fifth fixed ratio coupling 222 is coupled to a third node 224. The third node 224 is coupled to a sixth fixed ratio coupling 226. The sixth fixed ratio coupling 226 is coupled to the second traction ring of the CVP 100. In some embodiments, the third node 224 is coupled to a seventh fixed ratio coupling 228. The seventh fixed ratio coupling 228 is operably coupled to a third rotatable shaft 230. The third rotatable shaft 230 is configured to transfer power in or out of the powertrain 200.

Referring now to FIG. 29, in some embodiments, a hybrid powertrain 300 provided with a first rotatable shaft 302 configured to transfer power in or out of the hybrid powertrain 300. The first rotatable shaft 302 is operably coupled to a first fixed ratio coupling 304. The first fixed ratio coupling 304 is coupled to a first node 306 through a first planetary 308. In some embodiments, the first node 306 is coupled to a second planetary 310. In some embodiments, the first node 306 is coupled to a second fixed ratio coupling 312. The second fixed ratio coupling 312 is coupled to a second node 314. The second node 314 is configured to couple to a third fixed ratio coupling 316. A second rotatable shaft 318 is coupled to the third fixed ratio coupling 316 and configured to transfer power in or out of the hybrid powertrain 300. In some embodiments, the second node 314 is coupled to a fourth fixed ratio coupling 320. The fourth fixed ratio coupling 320 is coupled to the first traction ring of the CVP 100. In some embodiments, the second planetary 310 is operably coupled to a fifth fixed ratio coupling 322. The fifth fixed ratio coupling 322 is coupled to a third node 324. The third node 324 is coupled to a sixth fixed ratio coupling 326. The sixth fixed ratio coupling 326 is coupled to the second traction ring of the CVP 100. In some embodiments, the third node 324 is coupled to a seventh fixed ratio coupling 328. The seventh fixed ratio coupling 328 is operably coupled to a third rotatable shaft 330. The third rotatable shaft 330 is configured to transfer power in or out of the powertrain 300.

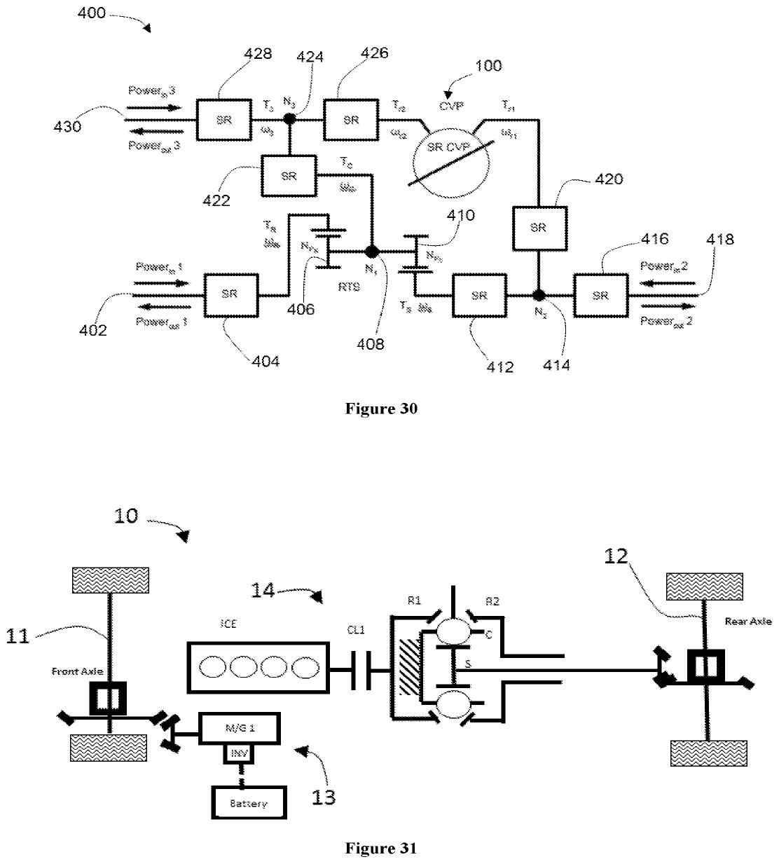

Referring now to FIG. 30, in some embodiments, a hybrid powertrain 400 provided with a first rotatable shaft 402 configured to transfer power in or out of the hybrid powertrain 400. The first rotatable shaft 402 is operably coupled to a first fixed ratio coupling 404. The first fixed ratio coupling 404 is coupled to a first planetary 406. The first planetary 406 is coupled to a first node 408. In some embodiments, the first node 408 is coupled to a second planetary 410. In some embodiments, the second planetary 410 is coupled to a second fixed ratio coupling 412. The second fixed ratio coupling 412 is coupled to a second node 414. The second node 414 is configured to couple to a third fixed ratio coupling 416. A second rotatable shaft 418 is coupled to the third fixed ratio coupling 416 and configured to transfer power in or out of the hybrid powertrain 400. In some embodiments, the second node 414 is coupled to a fourth fixed ratio coupling 420. The fourth fixed ratio coupling 420 is coupled to the first traction ring of the CVP 100. In some embodiments, the first node 408 is operably coupled to a fifth fixed ratio coupling 422. The fifth fixed ratio coupling 422 is coupled to a third node 424. The third node 424 is coupled to a sixth fixed ratio coupling 426. The sixth fixed ratio coupling 426 is coupled to the second traction ring of the CVP 100. In some embodiments, the third node 424 is coupled to a seventh fixed ratio coupling 428. The seventh fixed ratio coupling 428 is operably coupled to a third rotatable shaft 430. The third rotatable shaft 430 is configured to transfer power in or out of the powertrain 400. It should be noted that the term “node” used herein is in reference to any mechanical coupling of rotating components configured to transmit rotational power.

Passing now to FIG. 31, a vehicle 10 has a front axle 11 and a rear axle 12. The front axle 11 is operably coupled to an electric drive system 13 having at least one motor-generator. The rear axle 12 is operably coupled to a drivetrain 14 having a CVP. In some embodiments, the drivetrain 14 is optionally configured to have electric motor/generators or other devices such as the embodiments disclosed in FIGS. 1-30. In some embodiments, the CVP is optionally configured to be a multi-mode hybrid transmission as depicted in FIGS. 28-30, among others. In some embodiments, the electric drive system 13 is optionally configured to couple to the rear axle 12 and the drivetrain 14 is optionally configured to couple to the front axle 11.

Provided herein is a powertrain having one motor/generator MG1; an engine ICE; and a continuously variable planetary transmission (CVP) 100 comprising a plurality of balls, a first traction ring R1, a second traction ring R2, a sun S, and a carrier C, wherein each ball of the plurality of balls is provided with a tiltable axis of rotation, each ball is in contact with the first traction ring R1 and the second traction ring R2, each ball is in contact with a sun S wherein the sun S is located radially inward of each ball, and each ball is operably coupled to the carrier C which is operably coupled to a shift actuator, wherein the engine ICE is operably coupled to the first traction ring R1, and wherein the carrier C is grounded and non-rotating. In some embodiments, a first motor/generator MG1 is operably coupled to the sun S. In some embodiments, a second motor/generator MG2 is operably coupled to the second traction ring R2. In some embodiments, the powertrain comprises a first clutch CL1 operably coupled to the second motor/generator MG2, wherein the first clutch CL1 is arranged to selectively engage the second traction ring R2. In some embodiments, the powertrain comprises a first clutch CL1 operably coupled to the first motor/generator MG2, wherein the first clutch CL1 is adapted to selectively engage the sun S. In some embodiments, the powertrain comprises a brake B1 operably coupled to the second traction ring R2. In some embodiments, the second motor/generator MG2 is operably coupled to a final drive gear. In some embodiments, the powertrain comprises a powertrain supervisory controller, wherein the controller is configured to supply control signals to the powertrain or components thereof such that the said controller dynamically affects a plurality of operating modes of the powertrain.

Provided herein is a powertrain having at least one motor/generator MG1; an engine ICE; a first clutch CL1 coupled to the engine ICE; and a continuously variable planetary transmission comprising a plurality of balls, a first traction ring R1, a second traction ring R2, a sun S, and a carrier C, wherein each ball is provided with a tiltable axis of rotation, each ball is in contact with the first traction ring R1 and the second traction ring R2, each ball is in contact with the sun S, wherein the sun S is located radially inward of each ball, and each ball is operably coupled to the carrier C, wherein the carrier C is operably coupled to a shift actuator, wherein the engine ICE is selectively coupled to the first traction ring R1, and wherein the carrier C is grounded and non-rotating. In some embodiments, a first motor/generator MG1 is operably coupled to the sun S. In some embodiments, a second motor/generator MG2 is operably coupled to the second traction ring R2. In some embodiments, the powertrain comprises a second clutch CL2 operably coupled to the second motor/generator MG2, wherein the second clutch CL2 is arranged to selectively engage the second traction ring R2. In some embodiments, the powertrain comprises a second clutch CL2 operably coupled to the first motor/generator MG1, wherein the first clutch CL1 is adapted to selectively engage the sun S. In some embodiments, the powertrain comprises a brake B1 operably coupled to the second traction ring R2. In some embodiments, the second motor/generator MG2 is operably coupled to a final drive gear. In some embodiments, the powertrain comprises a powertrain supervisory controller, wherein the controller is configured to supply control signals to the powertrain or components thereof such that the said controller dynamically affects a plurality of operating modes of the powertrain.

Provided herein is a powertrain having at least one motor/generator MG1; an engine ICE; a first clutch CL1 coupled to the engine ICE; and a continuously variable planetary transmission (CVP) 100 comprising a plurality of balls, a first traction ring R1 in contact with each ball of the plurality of balls, a second traction ring R2 in contact with each ball of the plurality of balls, a sun S located radially inward of each ball of the plurality of balls and in contact with each ball of the plurality of balls, a carrier C operably coupled to each ball of the plurality of balls and operably coupled to a shift actuator, wherein each ball of the plurality of balls is provided with a tiltable axis of rotation, wherein the engine ICE is selectively coupled to the first traction ring R1, and wherein the carrier C is grounded and non-rotating. In some embodiments, a first motor/generator MG1 is operably coupled to the sun S. In some embodiments, a second motor/generator MG2 is operably coupled to the second traction ring R2. In some embodiments, the powertrain comprises a second clutch CL2 operably coupled to the second motor/generator MG2, wherein the second clutch CL2 is arranged to selectively engage the second traction ring R2. In some embodiments, the powertrain comprises a second clutch CL2 operably coupled to the first motor/generator MG1, wherein the first clutch CL1 is adapted to selectively engage the sun S. In some embodiments, the powertrain comprises a brake B1 operably coupled to the second traction ring R2. In some embodiments, the second motor/generator MG2 is operably coupled to a final drive gear. In some embodiments, the powertrain comprises a powertrain supervisory controller, wherein the controller is configured to supply control signals to the powertrain or components thereof such that the said controller dynamically affects a plurality of operating modes of the powertrain.

Provided herein is a powertrain having at least one motor/generator MG1; an engine ICE; a continuously variable planetary transmission (CVP) 100 comprising a plurality of balls, a first traction ring R1, a second traction ring R2, a sun S, and a carrier C; and a planetary gearbox PC operably coupled to the CVP 100 and the first motor/generator MG1; wherein each ball is provided with a tiltable axis of rotation, each ball is in contact with the first traction ring R1 and the second traction ring R2, each ball is in contact with a sun S, wherein the sun S is located radially inward of each ball, and each ball is operably coupled to the carrier C, wherein the carrier C is operably coupled to a shift actuator, and wherein the carrier C is grounded. In some embodiments, the planetary gearbox PC is operably coupled to a second motor/generator MG2. In some embodiments, the planetary gearbox PC is operably coupled to the engine ICE. In some embodiments, the engine ICE is operably coupled to the first traction ring R1, and the planetary gearbox PC is operably coupled to the second traction ring R2. In some embodiments, the planetary gearbox PC is operably coupled to the engine ICE, and a second motor/generator MG2 is operably coupled to the second traction ring R2. In some embodiments, the planetary gearbox PC is operably coupled to the first traction ring R1 and the sun S. In some embodiments, the powertrain comprises a powertrain supervisory controller, wherein the controller is configured to supply control signals to the powertrain or components thereof such that the said controller dynamically affects a plurality of operating modes of the powertrain.

Provided herein is a powertrain having at least one motor/generator MG1; an engine ICE; a continuously variable planetary transmission (CVP) 100 comprising a plurality of balls, a first traction ring R1 in contact with each ball of the plurality of balls, a second traction ring R2 in contact with each ball of the plurality of balls, a sun S located radially inward of each ball of the plurality of balls and in contact with each ball of the plurality of balls, a carrier C operably coupled to each ball of the plurality of balls and operably coupled to a shift actuator, wherein each ball of the plurality of balls is provided with a tiltable axis of rotation, and wherein the carrier C is grounded. In some embodiments, the planetary gearbox PC is operably coupled to a second motor/generator MG2. In some embodiments, the planetary gearbox PC is operably coupled to the engine ICE. In some embodiments, the engine ICE is operably coupled to the first traction ring R1, and the planetary gearbox PC is operably coupled to the second traction ring R2. In some embodiments, the planetary gearbox PC is operably coupled to the engine ICE, and a second motor/generator MG2 is operably coupled to the second traction ring R2. In some embodiments, the planetary gearbox PC is operably coupled to the first traction ring R1 and the sun S. In some embodiments, the powertrain comprises a powertrain supervisory controller, wherein the controller is configured to supply control signals to the powertrain or components thereof such that the said controller dynamically affects a plurality of operating modes of the powertrain.

Provided herein is a powertrain having at least one hydro-mechanical machine; an engine ICE; and a continuously variable planetary transmission (CVP) 100 comprising a plurality of balls, a first traction ring R1, a second traction ring R2, a sun S, and a carrier C, wherein each ball is provided with a tiltable axis of rotation, each ball is in contact with the first traction ring R1 and the second traction ring R2, each ball is in contact with the sun S, wherein the sun S is located radially inward of each ball, and each ball is operably coupled to a carrier C, wherein the carrier C is operably coupled to a shift actuator, wherein the engine ICE is operably coupled to the first traction ring R1, and wherein the carrier C is grounded and non-rotating. In some embodiments, a first hydro-mechanical machine is operably coupled to the sun S. In some embodiments, a second hydro-mechanical machine is operably coupled to the second traction ring R2. In some embodiments, the powertrain comprises a first clutch CL1 operably coupled to the second hydro-mechanical machine, wherein the first clutch CL1 is arranged to selectively engage the second traction ring R2. In some embodiments, the powertrain comprises a first clutch CL1 operably coupled to the first hydro-mechanical machine, wherein the first clutch CL1 is adapted to selectively engage the sun S. In some embodiments, the powertrain comprises a brake B1 operably coupled to the second traction ring R2. In some embodiments, the second hydro-mechanical machine is operably coupled to a final drive gear. In some embodiments, the powertrain comprises a powertrain supervisory controller, wherein the controller is configured to supply control signals to the powertrain or components thereof such that the said controller dynamically affects a plurality of operating modes of the powertrain.

Provided herein is a powertrain having at least one hydro-mechanical machine; an engine ICE; and a continuously variable planetary transmission (CVP) 100 comprising a plurality of balls, a first traction ring R1 in contact with each ball of the plurality of balls, a second traction ring R2 in contact with each ball of the plurality of balls, a sun S located radially inward of each ball of the plurality of balls and in contact with each ball of the plurality of balls, a carrier C operably coupled to each ball of the plurality of balls and operably coupled to a shift actuator, wherein each ball of the plurality of balls is provided with a tiltable axis of rotation, wherein the engine ICE is operably coupled to the first traction ring R1, and wherein the carrier C is grounded and non-rotating. In some embodiments, a first hydro-mechanical machine is operably coupled to the sun S. In some embodiments, a second hydro-mechanical machine is operably coupled to the second traction ring R2. In some embodiments, the powertrain comprises a first clutch CL1 operably coupled to the second hydro-mechanical machine, wherein the first clutch CL1 is arranged to selectively engage the second traction ring R2. In some embodiments, the powertrain comprises a first clutch CL1 operably coupled to the first hydro-mechanical machine, wherein the first clutch CL1 is adapted to selectively engage the sun S. In some embodiments, the powertrain comprises a brake B1 operably coupled to the second traction ring R2. In some embodiments, the second hydro-mechanical machine is operably coupled to a final drive gear. In some embodiments, the powertrain comprises a powertrain supervisory controller, wherein the controller is configured to supply control signals to the powertrain or components thereof such that the said controller dynamically affects a plurality of operating modes of the powertrain.

Provided herein is a vehicle having a first axle 11; a second axle 12; a drivetrain comprising a ball-planetary continuously variable transmission 14 operably coupled to the first axle 11; and an electric drive system 13 operably coupled to the second axle 12. In some embodiments, the ball-planetary continuously variable transmission 14 includes a plurality of balls, a first traction ring R1 in contact with each ball of the plurality of balls, a second traction ring R2 in contact with each ball of the plurality of balls, a sun S located radially inward of each ball of the plurality of balls and in contact with each ball of the plurality of balls, a carrier C operably coupled to each ball of the plurality of balls and operably coupled to a shift actuator, wherein each ball of the plurality of balls is provided with a tiltable axis of rotation. In some embodiments, the electric drive system 13 further comprises at least one motor-generator MG1.

It should be noted that where an ICE is described, the ICE is capable of being an internal combustion engine (diesel, gasoline, hydrogen) or any powerplant such as a fuel cell system, or any hydraulic/pneumatic powerplant like an air-hybrid system. Along the same lines, the battery is capable of being not just a high voltage pack such as lithium ion or lead-acid batteries, but also ultracapacitors or other pneumatic/hydraulic systems such as accumulators, or other forms of energy storage systems. The first motor/generator MG1 and the second motor/generator MG2 are capable of representing hydromotors actuated by variable displacement pumps, electric machines, or any other form of rotary power such as pneumatic motors driven by pneumatic pumps. The eCVT architectures depicted in the figures and described in text is capable of being extended to create hydro-mechanical CVT architectures as well for hydraulic hybrid systems.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein are capable of being employed in practicing the invention. It is intended that the following claims define the scope of the invention and that methods and structures within the scope of these claims and their equivalents be covered thereby.

Various embodiments as described herein are provided in the Aspects below:

Aspect 1: A powertrain comprising:
at least one motor/generator;
an engine;
a first clutch coupled to the engine; and
a continuously variable planetary transmission comprising a plurality of balls, a first traction ring, a second traction ring, a sun, and a carrier,
   wherein each ball is provided with a tiltable axis of rotation,
   wherein each ball is in contact with the first traction ring and the second traction ring,
   wherein each ball is in contact with the sun, wherein the sun is located radially inward of each ball, and
   wherein each ball is operably coupled to the carrier, wherein the carrier is operably coupled to a shift actuator,
wherein the engine is selectively coupled to the first traction ring, and
wherein the carrier is grounded and non-rotating.

Aspect 2: The powertrain of Claim 1, wherein a first motor/generator is operably coupled to the sun.

Aspect 3: The powertrain of Aspects 1 or 2, wherein a second motor/generator is operably coupled to the second traction ring.

Aspect 4: The powertrain of Aspects 1, 2, or 3, further comprising a second clutch operably coupled to the second motor/generator, wherein the second clutch is arranged to selectively engage the second traction ring.

Aspect 5: The powertrain of Aspects 1 or 2, further comprising a second clutch operably coupled to the first motor/generator, wherein the first clutch is adapted to selectively engage the sun.

Aspect 6: The powertrain of Aspects 1, 2, or 3, further comprising a brake operably coupled to the second traction ring.

Aspect 7: The powertrain of Aspects 1, 2, or 3, wherein the second motor/generator is operably coupled to a final drive gear.

Aspect 8: A powertrain comprising:
at least one motor/generator;
an engine;
a continuously variable planetary transmission (CVP) comprising a plurality of balls, a first traction ring, a second traction ring, a sun, and a carrier; and
a planetary gearbox operably coupled to the CVP and the first motor/generator;
wherein each ball is provided with a tiltable axis of rotation,
wherein each ball is in contact with the first traction ring and the second traction ring,
wherein each ball is in contact with a sun, wherein the sun is located radially inward of each ball, and
wherein each ball is operably coupled to the carrier, wherein the carrier is operably coupled to a shift actuator, and
wherein the carrier is grounded.

Aspect 9: The powertrain of Aspect 8, wherein the planetary gearbox is operably coupled to a second motor/generator.

Aspect 10: The powertrain of Aspects 8 or 9, wherein the planetary gearbox is operably coupled to the engine.

Aspect 11: The powertrain of Aspects 8 or 9, wherein the engine is operably coupled to the first traction ring and the planetary gearbox is operably coupled to the second traction ring.

Aspect 12: The powertrain of Aspect 8, wherein the planetary gearbox is operably coupled to the engine and a second motor/generator is operably coupled to the second traction ring.

Aspect 13: The powertrain of any one of Aspects 8-12, wherein the planetary gearbox is operably coupled to the first traction ring and the sun.

Aspect 14: A powertrain comprising:
at least one hydro-mechanical machine;
an engine; and
a continuously variable planetary transmission comprising a plurality of balls, a first traction ring, a second traction ring, a sun, and a carrier;
wherein each ball is provided with a tiltable axis of rotation,
wherein each ball is in contact with the first traction ring and the second traction ring,
wherein each ball is in contact with the sun, wherein the sun is located radially inward of each ball, and
wherein each ball is operably coupled to a carrier, wherein the carrier is operably coupled to a shift actuator,
wherein the engine is operably coupled to the first traction ring, and
wherein the carrier is grounded and non-rotating.

Aspect 15: The powertrain of Aspect 14, wherein a first hydro-mechanical machine is operably coupled to the sun.

Aspect 16: The powertrain of Aspects 14 or 15, wherein a second hydro-mechanical machine is operably coupled to the second traction ring.

Aspect 17: The powertrain of Aspects 14, 15, or 16, further comprising a first clutch operably coupled to the second hydro-mechanical machine, wherein the first clutch is arranged to selectively engage the second traction ring.

Aspect 18: The powertrain of Aspects 14 or 15, further comprising a first clutch operably coupled to the first hydro-mechanical machine, wherein the first clutch is adapted to selectively engage the sun.

Aspect 19: The powertrain of Aspects 14, 15, or 16, further comprising a brake operably coupled to the second traction ring.

Aspect 20: The powertrain of Aspects 14, 15, or 16, wherein the second hydro-mechanical machine is operably coupled to a final drive gear.

Aspect 21: A vehicle comprising:
a first axle;
a second axle;
a drivetrain comprising a ball-planetary continuously variable transmission operably coupled to the first axle; and
an electric drive system operably coupled to the second axle.

Aspect 22: The vehicle of Aspect 21, wherein the ball-planetary continuously variable transmission comprises a plurality of balls, a first traction ring in contact with each ball of the plurality of balls, a second traction ring in contact with each ball of the plurality of balls, a sun located radially inward of each ball of the plurality of balls and in contact with each ball of the plurality of balls, a carrier operably coupled to each ball of the plurality of balls and operably coupled to a shift actuator, wherein each ball of the plurality of balls is provided with a tiltable axis of rotation.

Aspect 23: The vehicle of Aspects 21 or 22, wherein the electric drive system further comprises at least one motor-generator.

1-7. (canceled)

8. A powertrain comprising:
a first motor/generator;
a second motor/generator;
an engine;
a continuously variable planetary transmission comprising a plurality of balls, a first traction ring, a second traction ring, a sun, and a carrier; and
a planetary gearbox including a ring gear, a planet carrier, and a sun gear,
wherein the second motor/generator and the first motor/generator are operably coupled to the planetary gearbox,
wherein each ball of the plurality of balls is provided with a tiltable axis of rotation,
wherein each ball is in contact with the first traction ring and the second traction ring,
wherein each ball is in contact with a sun wherein the sun is located radially inward of each ball, and
wherein each ball is operably coupled to the carrier,
wherein the engine is operably coupled to the planetary gearbox,
wherein the carrier is grounded and non-rotating, and
wherein a first motor/generator is operably coupled to the first traction ring.

9. The powertrain of claim 8, wherein the first motor/generator is coupled to the ring gear and the second motor/generator is coupled to the sun gear.

10. The powertrain of claim 8, wherein the first motor/generator is operably coupled to the first traction ring and the second traction ring is operably coupled to a final drive gear set.

11. The powertrain of claim 10 further comprising a first transfer gear is coupled to the second traction ring and the final drive gear set.

12. A powertrain comprising:
a first motor/generator;
a second motor/generator;
an engine;
a continuously variable planetary transmission comprising a plurality of balls, a first traction ring, a second traction ring, a sun, and a carrier; and
a planetary gearbox including a ring gear, a planet carrier, and a sun gear,
wherein the second motor/generator and the first motor/generator are operably coupled to the planetary gearbox,
wherein each ball of the plurality of balls is provided with a tiltable axis of rotation,
wherein each ball is in contact with the first traction ring and the second traction ring,
wherein each ball is in contact with a sun wherein the sun is located radially inward of each ball, and
wherein each ball is operably coupled to the carrier,
wherein the engine is operably coupled to the first traction ring, and
wherein the carrier is grounded and non-rotating.

13. The powertrain of claim 12, wherein the second traction ring is coupled to the planetary gearbox.

14. The powertrain of claim 12, wherein the first motor/generator is coupled to the ring gear and the second motor/generator is coupled to the sun gear.

15. The powertrain of claim 12, wherein the first motor/generator is operably coupled to a final drive gear set.

16. The powertrain of claim 15 further comprising a first transfer gear is coupled to the second traction ring and the planet carrier.

17. A powertrain comprising:
a first motor/generator;
a second motor/generator;
an engine;
a continuously variable planetary transmission comprising a plurality of balls, a first traction ring, a second traction ring, a sun, and a carrier; and
a planetary gearbox including a ring gear, a planet carrier, and a sun gear,
wherein the second motor/generator is operably coupled to the planetary gearbox.
wherein each ball of the plurality of balls is provided with a tiltable axis of rotation,
wherein each ball is in contact with the first traction ring and the second traction ring,
wherein each ball is in contact with a sun wherein the sun is located radially inward of each ball, and
wherein each ball is operably coupled to the carrier,
wherein the engine is operably coupled to planetary gearbox,
wherein the first motor/generator is operably coupled to the second traction ring and
wherein the carrier is grounded and non-rotating.

18. The powertrain of claim 17, wherein the first traction ring is operably coupled to the ring gear and the second motor/generator is operably coupled to the sun gear.

19. The powertrain of claim 17, wherein the second motor/generator is operably coupled to the sun gear and the first motor/generator is operably coupled to a final drive gear set.

20. The powertrain of claim 19 further comprising a first transfer gear operably coupled to the second traction ring and the first motor/generator.
